(19) United States
(12) Patent Application Publication
(10) Pub. No.: US 2025/0269330 A1
(43) Pub. Date: Aug. 28, 2025

(54) ADAPTIVE CLEANING-IN-PLACE METHOD FOR A MEMBRANE FILTRATION SYSTEM

(71) Applicant: Grundfos Holding A/S, Bjerringbro (DK)

(72) Inventors: Sebastien D'ANTONIO, Bjerringbro (DK); Dominik Marek DOMINIAK, Bjerringbro (DK); Victor Augusto YANGALI-QUINTANILLA, Bjerringbro (DK); Loreen Ople VILLACORTE, Bjerringbro (DK); Bozena SEREDYNSKA-SOBECKA, Bjerringbro (DK)

(21) Appl. No.: 18/857,784

(22) PCT Filed: Apr. 17, 2023
(86) PCT No.: PCT/EP2023/059900

§ 371 Date: Oct. 17, 2024

(30) Foreign Application Priority Data
Apr. 20, 2022 (DK) PA202270206

(51) Int. Cl. B01D 65/02; B01D 61/12

(52) U.S. Cl. CPC B01D 65/02; B01D 61/12; B01D 2321/10; B01D 2321/12; B01D 2321/162; B01D 2321/168; B01D 2321/40

(57) ABSTRACT

A cleaning-in-place method for cleaning a membrane filter module, the membrane filter module including a membrane having a feed side and a permeate side and being configured to filter a fluid passing through the membrane from the feed side to the permeate side; wherein the method comprises performing a sequence of process cycles, the sequence comprising at least one monitored process cycle, the monitored process cycle comprising: providing a flow of a liquid through the membrane and/or across the feed side of the membrane; monitoring at least one hydraulic parameter associated with the provided flow of the liquid; and terminating the flow of the liquid, when the at least one monitored hydraulic parameter meets a predetermined cycle completion criterion.

### TECHNICAL FIELD

The present invention relates to a cleaning-in-place method for cleaning a membrane filter module as well as to a filter system including at least one membrane.

### BACKGROUND

Membrane technology is widely applied for treatment of e.g. water and wastewater. There are different types of membrane filter modules that differ in parameters such as pore size, filter structure, applied pressure. For example, microfiltration (MF) typically employs membranes having pore size on a micrometer scale, while ultrafiltration (UF) filters have pores of about 10 nm. Nanofiltration (NF) membranes have even smaller pores, e.g. in the range of 1 nm to about 5 nm, while reverse osmosis (RO) membranes are non-porous. NF and RO filtration are widely used membrane processes for water and wastewater treatment in addition to other applications such as desalination.

Regardless of the membrane type, membrane filter modules need to be cleaned from time to time. MF and UF filter modules are often subjected to regular backwash cycles supplemented with occasional chemical cleaning cycles that are carried out at larger intervals. For NF and RO filters, chemical cleaning is the primary cleaning process.

For the purpose of the present description, chemical cleaning of membrane filter modules will also be referred to as cleaning-in-place (CIP). For the purpose of the chemical cleaning, the normal filtration operation has to be interrupted for the duration of the chemical cleaning. Moreover, chemical cleaning processes utilize chemical cleaning agents. For these reasons, it is generally desirable to reduce the frequency of chemical cleaning cycles and the duration of the individual chemical cleaning cycles as much as possible and practical.

EP 2 985 069 discloses a method for detecting the need of cleaning-in-place to be initiated. However, it remains desirable to efficiently control the duration of the individual CIP process.

EP 3 881 927 A1 discloses a method for determining when a CIP process is to be stopped. In this prior art method, the CIP process includes a number of backwash cycles, and the CIP process is terminated, if a deviation of a currently detected value of a backwash hydraulic parameter from a value of the same backwash hydraulic parameter detected in a previous backwash cycle in the same cleaning-in-place process is smaller than a predefined deviation limit value.

However, it remains desirable to provide a method that allows the duration of the CIP process to be further reduced. Moreover, it remains desirable to provide a method that can also be applied to CIP processes, in particular to CIP processes for NF or RO filter modules, that do not involve backwash cycles.

### SUMMARY

Thus, it remains desirable to provide a cleaning-in-place method and a corresponding filter system that solve one or more of the above problems and/or that have other benefits, or that at least provide an alternative to existing solutions.

According to one aspect, disclosed herein are embodiments of a cleaning-in-place method for cleaning a membrane filter module, the membrane filter module including a membrane having a feed side and a permeate side and being configured to filter a fluid passing through the membrane from the feed side to the permeate side; wherein the method comprises performing at sequence of process cycles, the sequence comprising at least one monitored process cycle, the monitored process cycle comprising:
providing a flow of a liquid through the membrane and/or across the feed side of the membrane;
monitoring at least one hydraulic parameter associated with the provided flow of the liquid; and
terminating the flow of the liquid, when the at least one monitored hydraulic parameter meets a predetermined cycle completion criterion.

Accordingly, the duration of at least one process cycle of the cleaning-in-place process is adaptively determined based on the monitored hydraulic parameter, i.e. the duration of the individual process cycle can be kept short. In particular, prolonging the individual process cycle beyond what provides an increased cleansing effect may be avoided.

Typically, a cleaning-in-place process comprises a sequence of multiple process cycles. For example, many CIP processes of MF/UF filter modules involve alternating chemical cleaning cycles and backwashing cycles. CIP processes for NF/OR filter modules often comprise a sequence of alternating chemical cleaning and flushing cycles. For the purpose of the present description, the chemical cleaning cycles will also be referred to as CIP cycles. Generally, during a CIP cycle the membrane is exposed to a cleaning liquid that includes a chemical cleaning agent. Flushing refers to a process cycle where a flushing liquid, e.g. the feed liquid to be treated by the filter module or already filtered liquid, is fed through the membrane filter module without added chemical agents. Backwashing refers to a flushing cycle where a flushing liquid is fed through the membrane in a reverse direction, i.e. from the permeate side to the feed side.

A CIP cycle of an NF/RO filter module often comprises feeding a cleaning liquid, which includes a chemical cleaning agent, across the feed side of the membrane of the filter module. To this end the cleaning liquid may be fed through a feed channel of the membrane filter module across the feed side of the membrane and recirculated, e.g. into a supply tank for the cleaning liquid, after having traversed at least a portion of the feed side of the membrane. While a major portion of the cleaning liquid does not penetrate the membrane to the permeate side as a permeate flow during the CIP cycle of an NF/RO filter module, a minor amount of permeate flow may be provided, e.g. by keeping a permeate valve on the permeate side of the membrane open during the CIP cycle. This prevents the build-up of an excessively high counter pressure. Generally, during the CIP cycle, the chemical cleaning agent acts by loosening, dissolving or otherwise acting upon material deposited in the feed channel or on the membrane. A flushing cycle of an NF/RO system comprises feeding water or another flushing liquid through the feed channel of the membrane filter module and across the feed side of the membrane, so as to flush away any remaining, loosened material. After having passed across the membrane, the flushing liquid is collected as a concentrate flow, which typically goes to drain rather than being recirculated. As was described for the CIP cycle, also during the flushing cycle of an NF/RO filter, while a major portion of the flushing liquid does not penetrate the membrane to the permeate side as a permeate flow, a minor amount of permeate flow may be provided, e.g. by keeping a permeate valve on the permeate side of the membrane open during the flushing cycle.

Accordingly, in some embodiments, the monitored process cycle is a cleaning-in-place cycle and the liquid is a cleaning liquid, which comprises a chemical cleaning agent. For example, the cleaning liquid may be a CIP solution comprising water and a chemical cleaning agent. There are a variety of different chemical agents that may be used for CIP processes. Different chemical agents may be targeted to remove respective types of fouling. For example, acidic agents, e.g. citric acid, may be used to dissolve inorganic scaling. Alkaline solutions such as caustic may be used to dissolve organic material. In some instances, detergents and/or surfactants may be used to remove organic and particulate foulants. Yet another example of a cleaning liquid includes a chlorine solution, which may be used to control biofouling and for sanitation purposes. In some embodiments, a CIP process may employ multiple chemical agents, which may be applied during respective CIP cycles of the process.

In some embodiments, in particular in respect of NF/RO filter systems, the cleaning-in-place cycle comprises providing a recirculation flow of the liquid, in particular a cleaning liquid, across the feed side of the membrane while allowing a minor permeate flow from the feed side of the membrane through the membrane. The inventors have realized that even during the feeding of the cleaning liquid across the feed side of the membrane, monitored hydraulic parameters carry sufficient information about the progress of the cleaning process that they can be used to adaptively determine the duration of each individual cleaning cycle.

Alternatively or additionally, the adaptive termination of process cycles may also be applied to flushing cycles, e.g. forward flushing or backwashing cycles. Accordingly, in some embodiments, the monitored process cycle is a flushing cycle. In such embodiments, the liquid is a flushing liquid, which may comprise feed and/or permeate water, in particular feed and/or permeate water without added chemical cleaning agents. In particular, in some embodiments, the flushing cycle is a forward flushing cycle and comprises providing a flow of the flushing liquid from the feed side of the membrane and across the feed side of the membrane. As described above, a minor amount of the flushing liquid may penetrate the membrane during flushing. In other embodiments, the flushing cycle is a backwash cycle.

As mentioned above, a CIP process may involve a sequence of multiple process cycles. The sequence may include one or more cleaning-in-place cycles and one or more flushing cycles. Preferably, the duration of several or even all of the individual process cycles of the sequence may be adaptively determined as disclosed herein. Accordingly, in some embodiments, performing each of a plurality of process cycles comprises:
providing a flow of a liquid through the membrane and/or across the feed side of the membrane;
monitoring at least one hydraulic parameter associated with the provided flow of the liquid; and
terminating the flow of the liquid, when the at least one monitored hydraulic parameter meets a predetermined cycle completion criterion.

In addition to adaptively controlling the duration of individual process cycles, the process may further determine the number of process cycles to be performed. To this end, in some embodiments, performing at least one monitored process cycle of the plurality of process cycles comprises:
recording a current resulting value of the at least one monitored hydraulic parameter resulting from said monitored process cycle,
comparing the current resulting value of the at least one monitored hydraulic parameter with a previously recorded resulting value of the at least one monitored hydraulic parameter resulting from a previous process cycle of the plurality of process cycles, the previous process cycle preceding said monitored process cycle;
terminating the sequence of process cycles when the current and previously recorded values of the at least one monitored hydraulic parameter meet a predetermined process completion criterion.

In some embodiments, the decision as to whether to terminate the sequence of process cycles may be made after each individual process cycle or after each individual process cycle of a particular type, e.g. after each flushing cycle, or after respective groups of process cycles, e.g. every time a predetermined—or adaptively determined—number of process cycles has been performed. The process completion criterion may e.g. be fulfilled when the absolute or relative difference between the current resulting values and the previously recorded resulting values is less than a predetermined threshold. If more than one hydraulic parameters are monitored, the process may be terminated when the current and previously recorded values of at least one hydraulic parameter meets the process completion criterion or when the current and previously recorded values of each of the hydraulic parameters meet a process completion criterion. Other examples of process completion criteria may consider not only the latest two but additional resulting values, e.g. the resulting values from the previous three process cycles or groups of process cycles. In some embodiments, the process performs a current batch of a predetermined number of alternating CIP and flushing cycles, records a final value of the at least monitored hydraulic parameter resulting from the current batch. The batch may include one, two or more CIP cycles. Each CIP cycle may be preceded and followed by a flushing cycle. The final value may be determined from the final process cycle of the batch, typically a flushing cycle, or from an additional process cycle, e.g. an additional flushing cycle, following the batch. The process may then compare the final value resulting from the current batch with a corresponding previously recorded final value resulting from a previous batch, e.g. from a batch immediately preceding the current batch, and terminate the CIP process when the final value resulting from the current batch and the previously recorded final value meet a process completion criterion.

Generally, the at least one monitored hydraulic parameter includes one or more hydraulic parameters indicative of a progress of the monitored process cycle. The monitored hydraulic parameter may be a directly measured hydraulic parameter or a parameter derived from one or more measured hydraulic parameters. Accordingly, the method may comprise measuring, in particular repeatedly or continuously measuring, one or more hydraulic parameters during the monitored process cycle. Examples of measured hydraulic parameters include a liquid pressure measured by a pressure sensor of the hydraulic filter system and a flow rate measured by a flow sensor of the hydraulic filter system. Some embodiments of the method may use one or more of the measured hydraulic parameters directly as monitored hydraulic parameters while other embodiments derive, in particular compute, the at least one monitored hydraulic parameter from one or more of the measured hydraulic parameters. The method may include measuring a plurality of hydraulic parameters, e.g. liquid pressure and/or flow rate upstream and/or downstream of the filter module. To this end, the membrane filter system may comprise a feed pressure sensor and/or a feed flow sensor positioned on the feed side of the membrane filter module. Alternatively or additionally, the membrane filter system may comprise a permeate pressure sensor and/or a permeate flow sensor positioned on the permeate side of the membrane filter module. Yet alternatively or additionally, the membrane filter system may comprise a concentrate pressure sensor and/or a concentrate flow sensor positioned on a concentrate outlet or recirculation outlet of the membrane filter module.

In some embodiments, the at least one monitored hydraulic parameter is indicative of a membrane resistance against a flow through the membrane and/or indicative of a feed channel resistance of a feed channel of the membrane filter module, the feed channel being configured to direct a flow of the liquid across the feed side of the membrane.

Accordingly, as the amount of material deposited in the feed channels and/or on the membrane negatively influences the resistance of the feed channel or membrane, the feed channel resistance and membrane resistance are suitable indicators of whether prolonged cleaning actual provides an increased cleanliness of the membrane filter system. The hydraulic parameter indicative of the membrane or feed channel resistance may be the hydraulic membrane resistance or feed channel resistance itself. However, it will be appreciated that, alternative to the membrane resistance and/or feed channel resistance, other hydraulic parameters that are indicative of the feed channel resistance or membrane resistance may be used, in particular hydraulic parameters that are sufficiently related to the membrane or feed channel resistance to be indicative of the rate of change of the membrane or feed channel resistance during the course of the monitored process cycle. Examples of such alternative parameters include a feed channel permeability, the membrane permeability, combinations or functions of these parameters and/or other parameters that are related to the feed channel resistance or membrane resistance in such a manner that they are indicative of the feed channel resistance or membrane resistance or at least their rate of change.

The hydraulic parameters indicative of the feed channel resistance or membrane resistance may e.g. be determined based on suitable pressure and flow measurements.

In particular, in some embodiments, the method comprises determining the at least one hydraulic parameter indicative the membrane resistance from a measured liquid pressures on the feed side and the permeate side of the membrane and from a measured permeate flow through the membrane. Similarly, in some embodiments, the method comprises determining the at least one hydraulic parameter indicative of the feed channel resistance from a measured supply pressure into the feed channel, from a recirculation pressure out of the feed channel and from a recirculation flow out of the feed channel.

In some embodiments, the cycle completion criterion is fulfilled when the at least one monitored hydraulic parameter reaches a stationary state following a period of increase or decrease of said at least one monitored hydraulic parameter. Accordingly, the cycle completion criterion indicates that a further continuation of the monitored process cycle is expected to have no, or at least only very little, further effect on the monitored parameter and, hence, on the cleaning result. The stationary state may be a state during which a rate of change of the at least one monitored hydraulic parameter is below a predetermined threshold. The stationary state may be determined using known techniques from time-series analysis, e.g. based on a determination of an estimated gradient of the time series, a determination of the flatness of the time series, plateau detection, and/or the like.

In some embodiments, the at least one hydraulic parameter includes a first parameter indicative of a membrane resistance and a second parameter indicative of a feed channel resistance and wherein the cycle completion criterion is fulfilled when each of the first and second parameters reaches a stationary state. Accordingly, the monitored process cycle may continue as long as improvements to at least one of the feed channel resistance and the membrane resistance is detected, thus reducing the risk of prematurely terminating a process cycle that still has a beneficial effect. It will be appreciated that other types of process cycle termination criteria may be chosen, e.g. criteria that put different weight on progress in feed channel resistance and membrane resistance, respectively.

The present disclosure relates to different aspects including the method described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, disclosed herein are embodiments of a computer-implemented process of controlling a cleaning-in-place process for cleaning a membrane filter module, the membrane filter module including a membrane having a feed side and a permeate side and being configured to filter a fluid passing through the membrane from the feed side to the permeate side; wherein the cleaning-in place process comprises a sequence of process cycles, wherein the method comprises controlling at least one monitored process cycle of the sequence of process cycles, wherein controlling to the monitored process cycle comprises:
controlling the membrane filter system to provide a flow of a liquid through the membrane and/or across the feed side of the membrane;
monitoring at least one hydraulic parameter associated with the provided flow of the liquid; and
controlling the membrane filter system to terminate the flow of the liquid, when the at least one monitored hydraulic parameter meets a predetermined cycle completion criterion.

Accordingly, disclosed herein are embodiments of a data processing system configured to perform the steps of the computer-implemented steps of the method described herein. In particular, the data processing system may have stored thereon program code adapted to cause, when executed by the data processing system, the data processing system to perform the steps of the method described herein. The data processing system may be embodied as a single computer or other data processing device, or as a distributed system including multiple computers and/or other data processing devices, e.g. a client-server system, a cloud based system, etc. The data processing system may include a data storage device for storing the computer program and sensor data. The data processing system may include a communications interface for receiving measured pressure values and/or other types of sensor data.

In some embodiments, the data processing system may partly or completely be embodied as a suitably programmed or otherwise configured processing unit, e.g. a filter controller configured to control operation of the membrane filter system, or a pump controller of one or more pumps of a membrane filter system. Alternatively or additionally, the data processing system may include one or more data processing apparatus external to the membrane filter system.

The data processing system may receive measured values of one or more hydraulic parameters, e.g. in digital form or as an analogue signal, from one or more suitable sensors, e.g. one or more pressure sensors and/or one or more flow sensors. In embodiments where the one or more sensors are arranged externally to the data processing system, the data processing system may receive the measured values from the external sensor(s) via a suitable wired or wireless communicative connection, e.g. directly from the or each sensor or indirectly via one or more intermediate nodes.

According to one aspect, disclosed herein are embodiments of a membrane filter system configured to perform an embodiment of the CIP process described herein. The membrane filter system comprises a membrane and one or more sensors for measuring one or more quantities from which the at least one hydraulic parameters are derivable, e.g. one or more pressure sensors and/or one or more flow sensors. The membrane filter system may further comprise one or more pumps and/or controllable valves for controlling provision of the flow of a liquid through or across the membrane.

The membrane filter system may further comprise means for supplying a cleaning liquid for use during the CIP process. In particular, the membrane filter system may include a tank or other reservoir for supplying the cleaning liquid for use during the CIP process. Alternatively or additionally, the membrane filter system may comprise one or more dosing pumps configured to provide a metered amount of chemical cleaning agent, e.g. to add a metered amount of a chemical cleaning agent to water or another base liquid so as to provide a cleaning liquid that includes a predetermined concentration of the chemical cleaning agent. The dosing pump may be configured to add the chemical cleaning agent to the tank or reservoir water or it may be configured to add the chemical cleaning agent in-line to a liquid flow.

The membrane filter system may further comprise—or be communicatively coupled to—a data processing system, e.g. in the form of a filter control unit, communicatively coupled to the one or more sensors and/or the one or more pumps and/or the one or more valves. The data processing system is configured to perform the steps of the method described herein. As described herein, the data processing system may be embodied as a remote data processing system, which may be communicatively coupled to the membrane filter system. Alternatively, the data processing system may be embodied as an internal data processing unit of the membrane filter system or of a component thereof.

In some embodiments, the membrane filter system comprises a communications interface for wired or wireless communication with a remote data processing system.

For example, the communications interface may be a wireless interface, e.g. using Wifi, Bluetooth or another suitable wireless communications technology. In some embodiments, the membrane filter system may communicate directly with a user device, e.g. a suitably programmed personal computer, tablet or smartphone. Such communication may e.g. utilize Bluetooth or another short-range communications technology. In some embodiments, the membrane filter system may communicate with a remote data processing system via the internet, e.g. via a suitable router or another gateway device to which the membrane filter system may be connectable via a local wired or wireless connection, e.g. via a network cable, wifi, Bluetooth or the like. The remote data processing system may be a server computer, a cloud computing platform and/or the like. The remote data processing system may allow users to view and/or input data pertaining to the CIP cleaning via a suitable user device, such as a suitably programmed personal computer, a tablet, a smartphone or the like, which may be communicatively coupled to the remote data processing system via the internet or via another suitable computer or communications network.

The membrane filter system may be configured to communicate data pertaining to the membrane filter system and, in particular to the CIP cleaning thereof, with the remote data processing system via the communications interface. Examples of such data include measured or derived membrane or feed channel permeability or resistance, energy or chemical consumption, etc., which the membrane filter system may communicate to the remote data processing system. Other examples of such data include configuration data, such as thresholds for configuring the termination criteria, which the membrane filter system may receive from the remote data processing system.

Accordingly, the remote data processing system may perform some or all of the computational steps for the control of the CIP process. Regardless of whether the remote data processing system performs part of the CIP control, the remote data processing system may provide a user-interface for allowing a user to monitor the status of the filter system. The remote data processing system may also issue warnings or alerts or other notifications pertaining to the filter system, e.g. audible or visual alerts, alerts communicated via e-mail, SMS, or other forms of notifications, and/or the like.

The remote data processing system may also provide a user-interface allowing a user to set one or more configuration parameters pertaining to the CIP process, e.g. to set one or more termination thresholds.

It will be appreciated that, in some embodiments, the membrane filter system itself may provide a user interface for viewing information pertaining to the filter system and/or for setting configuration parameters. Hence, in some embodiments, a remote data processing system may be omitted or it may be provided in addition to a user-interface of the membrane filter system.

Yet another aspect disclosed herein relates to embodiments of a computer program configured to cause a data processing system to perform the acts of the computer-implemented method described above and in the following. A computer program may comprise program code means adapted to cause a data processing system to perform the acts of the computer-implemented method disclosed above and in the following when the program code means are executed on the data processing system. The computer program may be stored on a computer-readable storage medium, in particular a non-transient storage medium, or embodied as a data signal. The non-transient storage medium may comprise any suitable circuitry or device for storing data, such as a RAM, a ROM, an EPROM, EEPROM, flash memory, magnetic or optical storage device, such as a CD ROM, a DVD, a hard disk, and/or the like.

### BRIEF DESCRIPTION OF THE DRAWINGS

Preferred embodiments will be described in more detail in connection with the appended drawings, where:

FIG. 1A schematically illustrates a block diagram of a membrane filter system.

FIG. 1B schematically illustrates an example of components of a membrane filter module.

FIG. 1C schematically illustrates a more detailed view of an example of a filter apparatus of a membrane filter system.

FIG. 2A schematically illustrates an embodiment of a process cycle of an adaptive CIP process.

FIG. 2B illustrates how the feed channel and membrane resistances change during a process cycle.

FIG. 2C illustrates an example of a CIP process that includes a sequence of process cycles.

FIG. 3 schematically illustrates operation and CIP of a membrane filter system.

FIG. 4 shows a flowchart of an example of a CIP process.

FIG. 5 shows a flowchart of an example of a process cycle of a CIP process.

### DETAILED DESCRIPTION

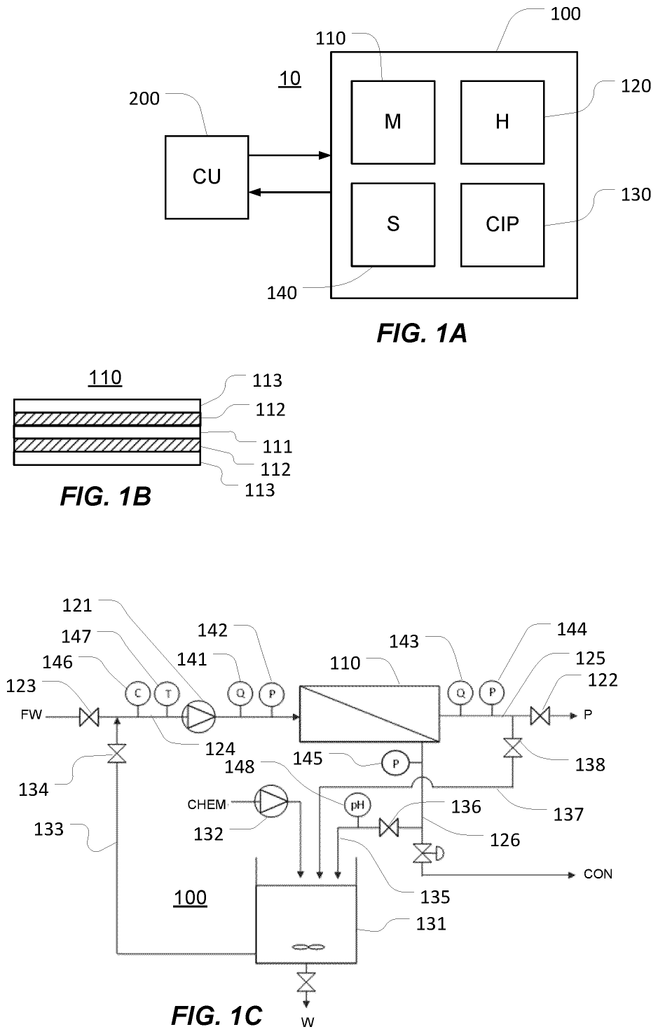

FIG. 1A schematically illustrates a block diagram of a membrane filter system. The membrane filter system, generally designated by reference numeral 10, comprises a membrane filter apparatus 100 and a data processing system 200.

The membrane filter apparatus 100 comprises a membrane filter module 110, a hydraulic system 120, a cleaning-in-place (CIP) system 130, and one or more sensors 140 for measuring one or more hydraulic and other operational parameters of the membrane filter apparatus.

The membrane filter module 110 includes a membrane having a feed side and a permeate side, opposite the feed side. During filtration operation, the hydraulic system 120 feeds liquid to the feed side of the membrane and through the membrane to the permeate side of the membrane. The filtered liquid, also referred to as permeate or filtrate, is then led away by the hydraulic system 120 from the permeate side of the membrane. The permeate side is sometimes also referred to as filtrate side of the membrane. Not all the liquid may actually pass through the membrane. In particular, a portion of the liquid may remain unfiltered on the feed side and be led away as so-called concentrate from the membrane filter by the hydraulic system.

Accordingly, the hydraulic system may comprise one or more pumps, one or more valves and conduits such as a pipes or hoses and be configured to feed liquid to be filtered to the membrane filter and to lead the filtered permeate away from the permeate side of the membrane filter, and to lead unfiltered concentrate away from the feed side of the membrane filter.

The liquid to be filtered may be water.

The membrane filter may be an NF or RO filter. However, in other embodiments, the membrane filter may be an MF or UF filter.

The cleaning-in-place system 130 is configured to feed a liquid to the feed side of the membrane filter. The liquid may be a flushing liquid, e.g. water or permeate, for flushing the filter or it may be a cleaning liquid, e.g. a CIP solution including water, or another base liquid, and one or more added chemical cleaning agents.

To this end the CIP system 130 may include one or more reservoirs for the cleaning liquid and/or the chemical cleaning agent. The CIP system 130 may further comprise one or more pumps, one or more valves and suitable conduits, in particular pipes or hoses. The CIP system may be integrated into, or otherwise use at least a part of, the hydraulic system that is used during normal filtration operations.

The sensors 140 may include one or more hydraulic sensors. In particular, the sensors 140 may include one or more pressure sensors, in particular a feed pressure sensor configured to measure the pressure of the feed flow to the feed side of the membrane, a permeate pressure sensor configured to measure the pressure of the permeate flow and/or a concentrate pressure sensor configured to measure the pressure of the concentrate or recirculation flow. The sensors 140 may further include one or more flow sensors, e.g. a feed flow sensor configured to measure the flow rate of the feed flow to the feed side of the membrane, a permeate flow sensor configured to measure the flow rate of the permeate flow and/or a concentrate flow sensor configured to measure the flow rate of the concentrate or recirculation flow. It will be appreciated that, in some embodiments, two flow sensors, e.g. a feed flow sensor and a permeate flow sensor, may be sufficient to determine the feed flow rate, the permeate flow rate as well as the concentrate flow rate. For example, the concentrate flow rate may be calculated as a difference between the feed flow rate and the permeate flow rate. It will further be appreciated that the sensors may be used to measure the respective hydraulic parameters during the filtration operation as well as during the CIP process. The sensors may include additional sensors, e.g. sensors for measuring various operational parameters pertaining to the membrane filter apparatus, such as pH, temperature, etc.

The data processing system 200 is communicatively coupled to the membrane filter apparatus 100 and is configured to communicate information with the membrane filter apparatus 100. In particular, the data processing system 200 may be in wired or wireless communicative connection to one or more components of the membrane filter apparatus, e.g. the sensors and/or the pumps and/or valves of the membrane filter apparatus. The data processing system 200 may be separate and, optionally, remote from the membrane filter apparatus 100 or it may be completely or partly be integrated into the membrane filter apparatus 100. For example, all or part of the data processing may be performed by a filter control circuit of the membrane filter apparatus.

The data processing system 200 is configured to receive information from the membrane filter apparatus 100, in particular information about hydraulic and, optionally, other operational parameters measured by the one or more sensors 140. The data processing system 200 is further configured to forward information to the membrane filter apparatus, in particular control information for controlling operation of the hydraulic system 120 and/or the CIP system 130.

FIG. 1B schematically illustrates an example of components of a membrane filter module 110, e.g. of the membrane filter module of the membrane filter apparatus described in connection with FIG. 1A or FIG. 1C. The membrane filter module 110 comprises a feed channel 111, a membrane 112 and a permeate channel 113. The membrane has a feed side facing the feed channel 111 and a permeate side, opposite the feed side, and facing the permeate channel 113. In particular, the membrane filter may be constructed as a layered structure including multiple layers, as schematically illustrated in FIG. 1B. In some embodiments, the layers may be wound around a central conduit so as to form a spirally wound filter module. Other embodiments of a membrane filter module may have a different structure. It will be appreciated, that a membrane filter module may include more than one membrane and/or more than one feed channel and/or more than one permeate channel. The feed channel 111 may define an empty void or it may be filled with a feed channel spacer material. Similarly, the permeate channel 113 may define an empty void or it may be filled with a permeate channel spacer material. During filtration operation, the liquid to be filtered enters the membrane filter module 110 through the feed channel 111 and penetrates the membrane 112. Liquid penetrating the membrane 112 is filtered by the membrane and then led out of the filter module as so-called permeate or filtrate via the permeate channel 113. Liquid and any matter not penetrating the membrane 112, the so-called concentrate, is led from the feed channel out of the filter module.

FIG. 1C schematically illustrates a more detailed view of an example of a membrane filter apparatus 100 of a membrane filter system, e.g. of the membrane filter system of FIG. 1A.

The membrane filter apparatus 100 comprises a membrane filter module 110, a hydraulic system, a CIP system and various sensors.

The membrane filter module 110 includes a membrane, a feed channel, a permeate channel and an output for concentrate, e.g. as described in connection with FIG. 1A or 1B.

The hydraulic system comprises a feed pump 121 for feeding feed water through a feed conduit 124 to the membrane filter module 110 and into the feed channel(s) and through the membrane of the membrane filter module. The hydraulic system may comprise a feed valve 123 for closing the feed water supply. The hydraulic system further comprises a permeate conduit 125 for leading the filtered permeate from the permeate side of the membrane filter module 110 to a downstream recipient of the filtered permeate. The hydraulic system may include a permeate valve 122 for preventing flow towards a downstream recipient, e.g. during chemical cleaning. The hydraulic system further includes a concentrate conduit 126 for leading unfiltered concentrate away from the feed side of the membrane of the membrane filter module 110.

The CIP system comprises a CIP tank 131 or other suitable reservoir for accommodating and supplying liquid for use during the CIP process. The reservoir may e.g. be filled with water or permeate to which chemical cleaning agents may be added. To this end, the CIP system may include a chemical cleaning agent supply pump 132, in particular a dosing pump or other suitable dosing or supply mechanism for the chemical cleaning agent. The CIP tank 131 is fluidly connected, via a CIP supply conduit 133, to the feed conduit 124, preferably downstream of the feed valve 123 and upstream of the feed pump 121. The CIP supply conduit 133 is provided with a CIP supply valve 134. The CIP system further includes a CIP recirculation conduit 135 for recirculating the cleaning liquid having passed across the feed side of the membrane back into the CIP tank. The CIP recirculation conduit is provided with a CIP recirculation valve 136. The CIP system further comprises a CIP permeate conduit 137 with a CIP permeate valve 138 for leading permeate from the permeate side of the membrane filter into the CIP tank 131.

The membrane filter apparatus 100 further comprises a feed flow sensor 141 and a feed pressure sensor 142 for measuring feed flow rate and feed liquid pressure, respectively, in the feed conduit 124, downstream of the feed pump 121. The membrane filter apparatus 100 further comprises a permeate flow sensor 143 and a permeate pressure sensor 144 for measuring permeate flow rate and permeate liquid pressure, respectively, in the permeate conduit 125. The membrane filter apparatus further comprises a concentrate pressure sensor 145 for measuring concentrate liquid pressure, respectively, in the concentrate conduit 126. It will be appreciated that alternative embodiments may include flow and/or pressure sensors arranged at alternative or additional locations of the hydraulic and/or CIP system.

Moreover, the membrane filter apparatus may include additional sensors for measuring other quantities, in particular other operational parameters. For example, the membrane filter apparatus of FIG. 1C is illustrated with a conductivity sensor 146 and a temperature sensor 147 in the feed conduit 124 and with a pH sensor 148 in the CIP concentrate conduit 135. The conductivity sensor 146 may be configured to measure the electrical conductivity of the feed water, which may be used as a measure of the salt concentration of the feed water.

It will be appreciated that, in some embodiments, various modifications may be made to the membrane filter apparatus, e.g. depending on the type of filter module, the type of liquid to be treated, the type of CIP process etc. For example, the provision of the CIP solution may be performed inline without use of a CIP tank. Some CIP system may include means for providing a backwashing, the placement of pumps and/or valves may be varied, etc.

Operation of an example of a membrane filter system will now be described with continued reference to FIGS. 1A-C. As described in connection with FIG. 1A, operation of the membrane filter apparatus may be controlled by a data processing system, e.g. e.g. by a filter control unit, based on the measurements of one or more of the sensors of the membrane filter apparatus. Operation of the membrane filter apparatus may be controlled by controlling the pumps 121 and 132 and/or the various valves of the membrane filter apparatus.

During filtration operation, the membrane filter apparatus receives feed water that is to be filtered via feed valve 123. Pump 121 pumps the feed water via feed conduit 124 to the feed side of membrane filter module 110 causing the feed water to enter the feed channel(s) 111 of the membrane filter, penetrate the membrane 112 from the feed side to the permeate side and exit the membrane filter via the permeate channel(s) 113 of the membrane filter as filtered permeate. The filtered permeate is led via permeate conduit 125 and permeate valve 122 to a downstream recipient of the filtered permeate. Any residual, unfiltered water not having penetrated filter membrane 112, may be led away from the feed side of the membrane via concentrate conduit 126. During filtration operation, the membrane filter module 110 may be fluidly isolated from the CIP system by CIP feed valve 134, CIP recirculation valve 136 and CIP permeate valve 138, which may be closed during normal filtration operation. Optionally, CIP permeate valve 138 may temporarily be opened in order to replenish CIP tank 131 with liquid.

During filtration operation, the membrane and feed channels of the membrane filter module are increasingly affected and the permeability of the membrane filter module is increasingly reduced. In particular, NF/RO filters are affected by cake fouling and/or scaling. For example in spiral wound NF/RO membranes, scaling occurs when salts up-concentrate and precipitate on the feed side of the membrane as the water permeates the membrane. As a consequence, incipient scaling occurs primarily on the membrane surface, and later spreads to the spacer filled channel. Particulate, organic and biological foulants typically accumulate on feed channels, especially those with spacers, but it can also form a layer on the surface of the membrane.

Accordingly, membrane filter modules require intermittent cleaning in order to remain effective and operational over extended periods of time. To this end, the membrane filter system is configured to intermittently perform a CIP process. The membrane filter system may be configured to perform a CIP process at predetermined intervals. Alternatively or additionally, the membrane filter system may be configured to perform a CIP process at adaptive intervals, e.g. based on a monitored hydraulic or other process parameters indicative of the degradation of the filter performance over time. In some embodiments, the chemical CIP process may require certain preconditions inherent to the fluid treatment application, where the effects of temperature and pH may be of importance.

The CIP process may comprise a sequence of process cycles, in particular one or more CIP cycles and one or more flushing and/or backwashing cycles. During CIP cycles, the membrane filter module is subjected to a cleaning liquid comprising a chemical cleaning agent. For example, the cleaning liquid may be a CIP solution comprising feed water and/or permeate water and an added chemical cleaning agent. The CIP cycle may include soaking and/or recirculation of the cleaning liquid including the chemical cleaning agent to the membrane unit. In NF/RO filters, the cleaning liquid may be fed through the feed channels of the membrane filter module, across the feed side of the membrane, and recirculated from the feed side of the membrane.

During flushing cycles, permeate and/or feed water, in particular permeate or feed water without any added chemical cleaning agents, is fed through the membrane filter module. Flushing is typically implemented before and after every CIP cycle with the purpose of removing large loose foulants and/or removing CIP chemicals from the membrane system after chemical application. In NF/RO filters, the flushing typically involves the water being fed through the filter membrane module from the feed side and across the feed side of the membrane. As described above, a minor amount of the flushing liquid may penetrate the membrane to the permeate side during flushing. Alternatively or additionally to forward flushing, backwashing may be applied where water is fed through the membrane in the reverse direction, i.e. from the permeate side to the feed side. Backwashing is predominantly performed in MF/UF filters.

Still referring to FIGS. 1A-C, when a CIP process is to be performed, flushing cycles may be performed by either pumping feed water or permeate via feed conduit 124 through the membrane filter module 110. When feed water is used as flushing liquid during the flushing cycle, the feed water is received via feed valve 123. When permeate water is used, previously collected permeate may be pumped from CIP tank 131 via CIP feed conduit 133 and CIP feed valve 134 toward into the membrane filter. In any event, after having passed across the feed side of the membrane, the flushing water may be led away as a concentrate flow and discarded, e.g. to a drain, via concentrate conduit 126. Any flushing water having penetrated the membrane may be led away from the permeate side to drain. During the CIP process, the membrane filter module 110 and the CIP system may be fluidly isolated from the downstream system by closing permeate valve 122.

During a CIP cycle, a CIP solution is prepared in the CIP tank, e.g. by adding a chemical cleaning agent to permeate collected in the CIP tank and often heating up the mix to the desired temperature. Alternatively, the CIP solution may be prepared inline or in another manner.

The CIP solution is then brought into contact with the feed side of the membrane and recirculated over the feed side of the membrane with a pump. This way, the CIP solution cleans both the feed side of the membrane and the membrane feed channels.

Membrane feed channels can be open unobstructed channels such as in capillary/tubular membranes or spacer-filled channels such as in spiral wound membranes. During this process, a CIP permeate valve may be kept open to mitigate the risk of excessive build-up of back-pressure from permeate side of the membrane—the consequence of that is a small permeate flow resulting from filtering the CIP solution.

For example, the CIP solution may be pumped by feed pump 121 is pumped via CIP feed channel 133 and CIP feed valve 134 to the feed side of the membrane filter module 110, across the feed side of the membrane 112, and recirculated to the CIP tank 131 via CIP recirculation conduit 135. During the CIP cycle, the CIP permeate valve 138 may also be kept open so as to avoid excessive backpressure. Any CIP solution passing through the membrane 112 will thus be led back into CIP tank 131 via CIP permeate conduit 137.

The duration of the individual CIP cycles and/or flushing cycles may be adaptively controlled, as will be described below. Similarly, the number of process cycles to be performed may be adaptively controlled, as will also be described below.

The adaptive CIP control for membrane systems is based on information gathered from hydraulic sensors and optimizes the CIP process by optimizing the duration of some or each process cycle and, optionally, the overall number of process cycles to be performed.

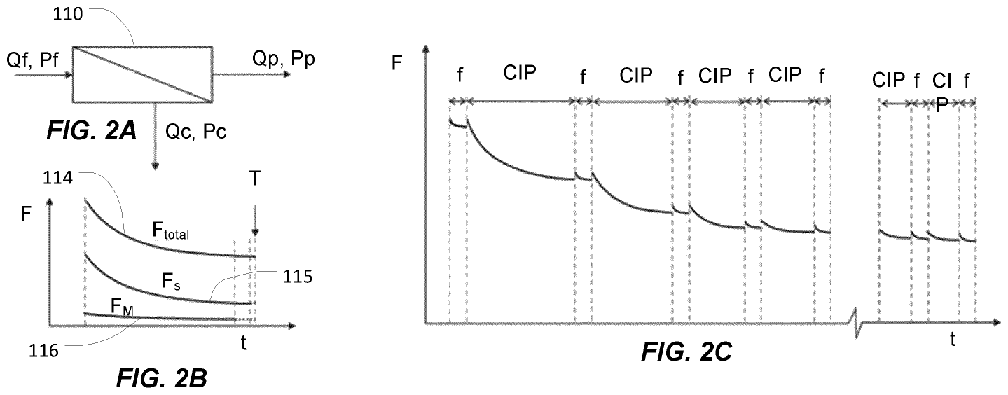

FIG. 2A schematically illustrates an embodiment of a monitored process cycle of an adaptive CIP process for cleaning a membrane filter module 110. Generally, the monitored process cycle comprises providing a flow of a liquid from the feed side of the membrane through the membrane and/or across the feed side of the membrane. The process further monitors at least one hydraulic parameter associated with the provided flow of the liquid, and terminates the flow of the liquid, when the at least one monitored hydraulic parameter meets a predetermined cycle completion criterion.

The monitored hydraulic parameter may be a parameter that can directly be measured by a suitable sensor, e.g. by a pressure sensor, a flow sensor, or the like, or the hydraulic parameter may be a parameter that is derivable from one or more measured variables. Examples of derived hydraulic parameters include a hydraulic resistance or permeability or a related hydraulic parameter indicative of a hydraulic resistance or permeability. For the purpose of controlling the CIP process of a membrane filter, the hydraulic parameter may be based on one or more measured hydraulic parameters chosen from the following parameters:
The feed flow rate Q_{f} of the liquid being fed into the membrane filter. In the apparatus of FIG. 1C, the feed flow rate may be measured by a feed flow sensor 141 located in the feed conduit leading into the membrane filter module 110.
The feed liquid pressure P_{f} of the liquid being fed into the membrane filter. In the apparatus of FIG. 1C, the feed liquid pressure may be measured by a pressure sensor 142 located in the feed conduit leading into the membrane filter module 110.
The permeate flow rate Qₚ of the permeate liquid having penetrated the membrane filter. In the apparatus of FIG. 1C, the permeate flow rate may be measured by a permeate flow sensor 143 located in the permeate conduit on the permeate side of the membrane filter module 110.
The permeate liquid pressure Pₚ of the permeate liquid having penetrated the membrane filter. In the apparatus of FIG. 1C, the permeate liquid pressure may be measured by a permeate pressure sensor 144 located in the permeate conduit on the permeate side of the membrane filter module 110.
The concentrate/recirculation flow rate Q_{c} of the liquid having passed across the feed side of the membrane without having penetrated the membrane 112. The concentrate/recirculation flow rate may be measured by a concentrate/recirculation flow sensor located in the concentrate conduit. Alternatively, as in the example of FIG. 1C, the concentrate/recirculation flow rate may be derived from the measured feed flow rate and the measured permeate flow rate.
The concentrate/recirculation liquid pressure P_{c} of the recirculated liquid having traversed across the feed side of the membrane without having penetrated the membrane filter. In the apparatus of FIG. 1C, the concentrate/recirculation pressure may be measured by a concentrate pressure sensor 145 located in the concentrate conduit 126.

It will be appreciated that some embodiments may measure all of the above parameters. Other embodiments may measure only a subset of the above parameters and/or alternative parameters. Moreover, some of the above parameters and/or other parameters may be derived from measured parameters.

In some embodiments, the decision to terminate the monitored process cycle is based on the monitored membrane resistance of the filter membrane and/or on the monitored feed channel resistance of the feed channels of the membrane filter and/or on a parameter indicative of the membrane resistance and/or feed channel resistance.

In one embodiment, the decision is based on a channel resistance parameter

$${C}_{c} = \frac{{Q}_{c}^{2}}{( {P}_{f} - {P}_{c} )} ,$$

and/or on a membrane resistance parameter related to the total resistance of the feed channel and the membrane:

$${C}_{M} = \frac{{Q}_{p}^{2}}{( {P}_{f} - {P}_{p} )} .$$

FIG. 2B illustrates how the feed channel and membrane resistances change during a process cycle. In particular, curve 114 illustrates the total resistance of the feed channel and the membrane, i.e. the resistance to fluid flow through the feed channel and the membrane. Similar, curve 115 illustrates the resistance of the feed channel and curve 116 illustrates the resistance of the membrane alone. Generally, the resistances drop from respective initial values at the beginning of the monitored process cycle and gradually flatten out towards a final value. Accordingly, while the monitored process cycle initial causes a strong improvement of the filter permeability, the effect gradually decreases to a point where continued flushing or chemical cleaning does not provide any significant further improvement. Accordingly, the monitored process cycle may advantageously be terminated when the membrane and/or feed channel resistance flattens out.

The inventors have realised that pressure and flow measurements during the CIP cycles and the flushing cycles of a CIP process for cleaning membrane filter modules, even NF/RO filter modules, can be performed with sufficient accuracy that the duration of the CIP and flushing cycles can reliably be controlled based on these measurements.

During the CIP process cycle, the permeate flow Qₚ is usually small due to a small pressure gradient across the membrane, and it is affected by the pH, both of the current and the previous CIP stage (see e.g. Kezia Kezia et al., “The transport of hydronium and hydroxide ions through reverse osmosis membranes”, Journal of Membrane Science, vol. 459, 1 Jun. 2014, pages 197-206. Nevertheless, the inventors have found that the permeate flow is still useful for determining the moment to stop a given CIP stage. The possibility of membrane pore cleaning and cleaning the permeate line in porous membrane systems can be an added advantage. During the CIP cycle, the flow along the feed channel is larger than the flow through the membrane, as is the pressure drop along the feed channel. Combined, flow and pressure yield feed channel resistance during the CIP solution recirculation process. The feed channel resistance provides an adequate proxy for membrane resistance, yet without the pH effect typically seen in membrane resistance, which makes it more reliable when the pH effect on membrane resistance is strong, and/or when the trans-membrane flow during CIP solution recirculation is too small to be reliably measured with available flow meters. Accordingly, in some embodiments, the duration of the CIP cycle is controlled based on a determination of a parameter indicative of the feed channel resistance alone. In most cases however, both feed channel resistance and membrane resistance can be reliably measured during the CIP process stages. Accordingly, in some embodiments, the duration of the CIP cycle is controlled based on a determination of a parameter indicative of the feed channel resistance and on a determination of a parameter indicative of the membrane resistance.

One advantage of basing the termination decision on a parameter indicative of the membrane resistance is that it captures the effect of membrane cake fouling or scaling. At initial scaling stages, membrane resistance registers scaling better than feed channel resistance. Spacer-filled channels provide a large surface area, but take no part in permeation. As a consequence, a parameter indicative of feed channel resistance can be better suited to register organic fouling than the membrane resistance. In short, the effect of scaling is better visible through membrane resistance, and the effect of fouling is better visible through feed channel resistance. Therefore, the effects of alkali cleaning, acidic cleaning, enzymatic cleaning or any other type of cleaning can be tracked separately to some extent and improve the assessment of the CIP process.

FIG. 2C illustrates an example of a CIP process that includes a sequence of process cycles, including a plurality of CIP cycles (designated CIP in FIG. 2C) and a plurality of flushing cycles (designated f in FIG. 2C) performed in an alternating fashion. In particular, FIG. 2C illustrates how the feed channel resistance varies over time during the individual process cycles of the CIP process.

Flushing is typically implemented before and after every chemical application, i.e. before and after every CIP cycle, with the purpose of removing large loose foulants and/or removing CIP chemicals from the membrane filter module and hydraulic system after chemical application. The duration of each process cycle may be adaptively determined based on pressure and flow measurements as described herein. Accordingly, the duration of the individual process cycles may vary during the course of the CIP process, as indicated in FIG. 2C.

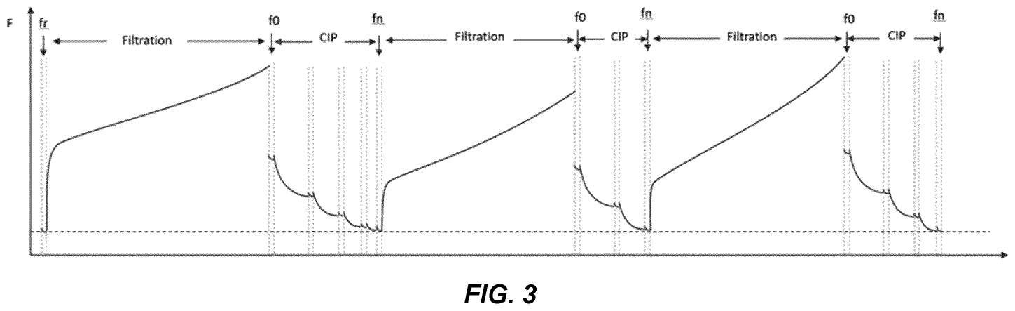

FIG. 3 schematically illustrates operation and CIP of a membrane filter system. FIG. 3 illustrates how the feed channel resistance varies over time during the filtration process and during the intermittent CIP processes. During the filtration process, i.e. during normal operation of the membrane filter system, the feed channel resistance gradually increases, e.g. due to the build-up of foulants and/or scaling. During the CIP processes, each of which is started and terminated by a flushing cycle, the feed channel resistance decreases again indicating that the efficiency of the filter is completely or at least partly restored. As is illustrated in FIG. 3, depending on how much fouling has been build up in the membrane filter module during the preceding filtration cycle, a different number of CIP cycles may be necessary to effectively clean it.

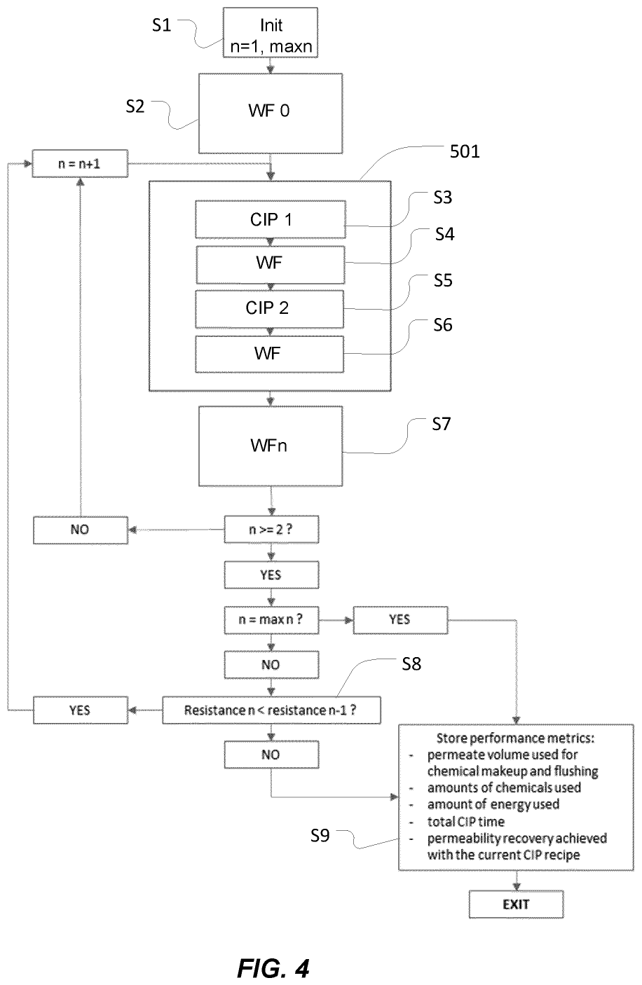

FIG. 4 shows a flowchart of an example of a CIP process. The process may be controlled by a data processing system, e.g. by a filter controller, e.g. by the data processing system 200 of FIG. 1A.

In an initial initialisation step S1, the process initialises a counter n and selects a maximum number of process cycles max n. The latter may e.g. be set to a predetermined value which may be user-selected while the former may be initialised to zero. The process may further control the membrane filter apparatus to prepare for the CIP process, e.g. by setting suitable valve positions in the system, such as so as to prevent chemical cleaning agents to be led downstream.

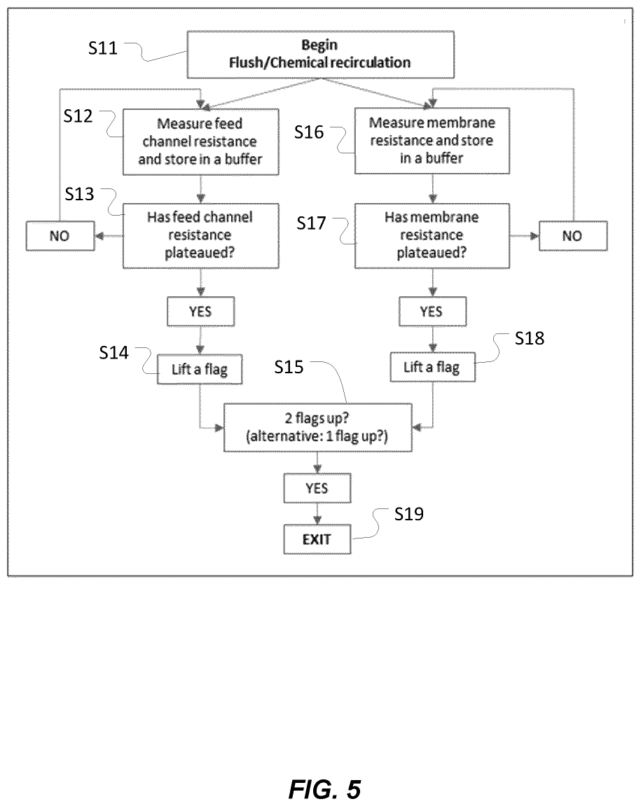

The process then initiates the CIP process, which includes a plurality of process cycles. At step S2, the process performs a flushing cycle as an initial process cycle. The initial flushing cycle may be a feed water flush, where feed water is pumped through the feed channel of the membrane filter module to sweep particles away from the membrane module. This process is useful in determining the initial condition of the membrane and the feed channel at the beginning of the CIP process. To this end, the process may measure pressure and flow data, and combine them into one or more resistance parameters indicative of feed channel and/or membrane resistance, e.g. the parameters C_{C} and C_{M} described above. The feed channel and membrane resistance initially drops and then settles at a substantially constant level when further flushing with feed water does not clean the membrane and the feed channel any further. Once the resistance settles at a constant level, the process stops the flushing to reduce downtime and energy consumption. The process stores the final value of the one or more resistance parameters for future reference. The determination of the moment when the one or more resistance parameters level out can be done in a variety of ways. An example process will be described below with reference to FIG. 5.

Still referring to FIG. 4, after completion of the initial flushing, the process initiates a CIP batch 501, which is a sequence of alternating CIP and flushing cycles. In the example of FIG. 4, the CIP batch 501 includes two CIP cycles S3 and S5, as well as two flushing cycles S4 and S6. It will be appreciated, however, that other embodiments of the process may include batches of fewer or more cycles. In some embodiments, each CIP cycle may include a single CIP cycle, whereas other embodiments may include more than two CIP cycles.

During each of the CIP cycles S3 and S5, chemical cleaning takes place using a CIP solution including an added chemical cleaning agent, e.g. an acid or alkaline cleaning agent. To this end, the process recirculates the CIP solution through the membrane filter module while monitoring one or more resistance parameters indicative of the membrane resistance and/or feed channel resistance value in real time. The process terminates each CIP cycle when the one or more monitored resistance parameters drop and plateau on a substantially constant level, e.g. using the method described below in connection with FIG. 5.

After each CIP cycle, the process performs a flushing cycle (steps S4 and S6 respectively), e.g. with permeate and/or feed water, in order to remove the CIP solution from the previous step from the membrane filter module. This process restores the pH of the membrane and prepares it for the next CIP solution cleaning stage. Each flushing cycle may be controlled in the same manner as the CIP cycles: One or more resistance parameters indicative of the membrane resistance and/or feed channel resistance are calculated from measured pressure and flow values and logged in real time, and the flushing cycle is stopped when the one or more resistance parameters have plateaued.

In the example of FIG. 4, after the first pair of CIP cycle S3 and flushing cycle S4 of CIP batch 501, another chemical cleaning is performed in CIP cycle S5. Generally, the CIP cycles of a CIP batch may utilize the same or different chemical cleaning agents. For example, CIP cycle S4 may utilize an acidic solution at low pH while CIP cycle S3 may utilize an alkaline CIP solution at high pH, or vice versa. In any event, the duration of CIP cycle S4 may be controlled in the same manner as the previous chemical cleaning. Each CIP solution circulates the system in an effort to remove whatever the chemical cleaning agent used in said CIP cycle is capable of dissolving, and one or more monitored resistance parameters are used to determine when the process is terminated.

The CIP batch 501 is concluded by a flushing cycle S6, e.g. with feed water or permeate, to remove the CIP solution from the membrane filter. This cycle is again terminated based on the monitored one or more resistance parameters.

After completion of the CIP batch 501, another flushing cycle S7, e.g. with feed water or permeate, is performed to assess the overall effect of the just completed CIP batch 501. The flushing cycle S7 may again be controlled based on the monitored one or more resistance parameters, and the final value(s) of the one or more resistance parameters are registered for future reference. In some embodiments, instead of performing a separate flushing cycle S7, the final flushing cycle S6 of CIP batch 501 may be used to assess and log the overall of result of CIP batch 501.

After performing the initial iteration of CIP batch 501 and subsequent flushing cycle S7, the process increments the counter n, which is thus indicative of the number of performed iterations of CIP batch 501, and returns to step S3 to perform another iteration of CIP batch 501, which may again be composed of a sequence of a first CIP cycle S3, followed by a flushing cycle S4, followed by a second CIP cycle S5, followed by another flushing cycle S6, as described above. Again, each process cycle may be terminated based on the monitored one or more resistance parameters. The second iteration of the CIP batch 501 may usually be kept shorter, because the majority of the cleaning has already taken place during the initial iteration of the CIP batch 501.

As during the initial iteration, after completion of CIP batch 501, another flushing cycle S7 is performed to assess the overall effect of the second iteration of CIP batch 501 as well as its relative effect compared to the previous iteration of the CIP batch 501.

Accordingly, after at least two iterations of the CIP batch 501 have been performed, and if the predetermined maximum number max n of iterations has not yet been reached, the process proceeds at step S8 and compares the final values of the one or more resistance parameters resulting from the current, n-th, iteration with the corresponding final values resulting from the previous, (n−1)-th, iteration. If the current iteration of CIP batch 501 has not provided any significant improvement over the previous iteration (or if the predetermined maximum number of iterations has been reached), the process terminates the overall CIP process and proceeds at step S9. Otherwise, the process increments the CIP batch counter n and returns to step S3 to start another iteration of CIP batch 501. For example, the process may determine to stop the overall CIP process when one or each of the final values of the resistance parameters resulting from the current iteration of CIP batch 501 does not differ from the corresponding value resulting from the previous iteration by more than a predetermined minimum threshold. Nevertheless, it will be appreciated that other process termination criteria may be used, e.g. based on a trend analysis involving more than two iterations of the CIP batch.

Depending on how much fouling had occurred during the filtration process preceding the CIP cleaning process, a different number of CIP batches will be necessary to effectively clean the filter, i.e. the total duration of the CIP process may vary, e.g. as illustrated in FIG. 3.

At final step S8, upon completion of the CIP process, the process performs an overall assessment of the CIP process, e.g. by calculating and logging one, several or all of the following parameters from the sensor readings recorded during the various process cycles of the CIP process:
The overall volume of permeate used for creating the CIP solutions and permeate flushing, optionally both computing the permeate directly used for making-up the CIP solution and flushing, as well as the permeate not produced due to CIP downtime.
The overall volume feed water used and discharged during the CIP process.
The overall amounts of all chemicals used in the CIP process.
The overall amount of energy used to run the CIP process (e.g. heating, recirculation with pumps etc.)
The total time necessary to perform the complete CIP process.
The overall recovery of permeability associated with the CIP process, as compared with the initial permeability at the beginning of the filtration sequence (right after a previous CIP process).

The above and/or other quantities may e.g. be used to calculate the overall cost of a given CIP recipe—the amount of money and time it takes to perform it—as well as the overall efficiency of cleaning. When these values are logged, it is possible to change the CIP chemicals and compare their relative cost and efficiency in pursuit of the most efficient and economical recipe. Moreover, since cleaning processes with different chemicals may be tracked separately, it is possible to determine which of the chemicals underperforms and to improve the recipe by swapping only that chemical. This creates an unprecedented insight into the CIP process and enables informed decision making around the process.

For example, one recipe successfully cleans a membrane with 3 CIP batches lasting 6 hours in total, costing a certain amount of money in electricity and chemicals and a 97% cleaning efficiency. Another recipe of similar cleaning efficiency needs 4 CIP batches lasting 8 hours in total, but using cheaper chemicals, which sets the overall cost lower.

Depending on the objectives and success criteria set up by the system user, a cheaper recipe could be desired, or perhaps a more expensive one is acceptable as long as it is shorter or substantially more effective at cleaning. The process disclosed herein is capable of providing all necessary information to take such decisions.

FIG. 5 shows a flowchart of an example of a monitored process cycle of a CIP process, e.g. of one or more, or even each of the process cycles of the process of FIG. 4, in particular of one, more or each of the CIP cycles and/or of one, more or each of the flushing cycles.

In step S11, the monitored process cycle is initiated by starting the feeding of the liquid, e.g. a CIP solution or a flushing liquid, to the membrane filter.

In step S12, while the liquid is being fed through and/or across the membrane of the membrane filter, the process measures one or more hydraulic parameters, in particular pressure and flow rates, from which a resistance parameter indicative of the feed channel resistance of the membrane filter is calculated and monitored, e.g. resulting in a feed channel resistance time series.

In step S13, the process determines from the recorded feed channel resistance time series, whether the feed channel resistance has levelled out, i.e. reached a substantially stationary level. This determination may be based on techniques known as such in the art of time series analysis, e.g. based on a computation of the slope over a sliding window of the time series. When the slope decreases to a value smaller than a threshold slope, the process may determine that the feed channel resistance parameter has levelled out. The threshold slope may be an absolute threshold or a relative threshold, e.g. relative to an initial slope determined at the beginning of the monitored process cycle. The threshold slope may be predetermined or adaptively determined. Other techniques for determining whether the resistance parameter has levelled out include a neural network or other machine-learning model trained to in recognizing the flatness of curves. To this end, the neural network or other machine-learning model may be trained based on training data including time series of resistance parameters up to different stages of completion of the process cycle. The machine-learning model may then be training to output a measure of the flatness of the curve, a measure of the degree of completion or simply to classify the curves into “not completed” and “completed”, respectively. To this end the training data may be labelled by the desired output.

It will be appreciated that hydraulic resistance calculated directly from flow and pressure measurements can be relatively noisy. Accordingly, the process may perform a smoothing operation of the signal. Alternatively or additionally, the process may perform other pre-processing steps, e.g. a scaling of the resistance parameter and/or of the measured pressure and flow readings. Yet further, it is appreciated that the process may compute the hydraulic resistance directly, or it may compute another parameter indicative of the hydraulic resistance, e.g. a function of the resistance or a combination of resistance and flow and/or pressure. Such parameters may be sufficiently related to the resistance that they carry sufficient information about the resistance/permeability of the filter to allow reliable control of the duration of the monitored process cycle. In any event, the parameter may be computed from the flow and pressure measurements, in particular from flow and pressure measurements alone.

In step S14, when the process has determined that the feed channel resistance has leveled out, the process sets a first flag and proceeds at step S15; otherwise, the process returns to step S12 and continues monitoring the feed channel resistance.

Concurrently with the monitoring of a parameter indicative of the feed channel resistance, in step S16, the process further computes and monitors a parameter indicative of the membrane resistance during the monitored process cycle. Again, the parameter indicative of the membrane resistance may be computed from corresponding pressure and flow measurements. The process may compute a corresponding time series of membrane resistance parameter values, optionally performing smoothing and/or scaling and/or other pre-processing steps. Again, the membrane resistance parameter may be the hydraulic membrane resistance or another parameter that is indicative of, i.e. carries sufficient information to allow a determination to be made as to when the membrane resistance levels out during the course of the monitored process cycle. For example, the resistance parameter may be indicative of a combined resistance of the feed channel and the membrane.

In step S17, the process determines from the recorded membrane resistance time series, whether the membrane has levelled out, i.e. reached a substantially stationary level. This determination may be made in a similar manner as has been described above in the context of the feed channel resistance.

In step S18, when the process has determined that the membrane channel resistance has leveled out, the process sets a second flag and proceeds at step S15; otherwise, the process returns to step S16 and continues monitoring the membrane resistance.

At step S15, when the first as well as the second flag have been set, i.e. both the membrane resistance and the feed channel resistance have leveled out, the process proceeds at step S19 and terminates the current process cycle. Accordingly, in the present embodiment of the process, two flags (one from membrane resistance value and one from feed channel resistance value) trigger the end of the monitored process cycle, e.g. the end of recirculation of the CIP solution, since no more useful effect can be achieved this way. In alternative embodiments, other cycle termination criteria may be used. For example, in some embodiments, the process terminates the monitored process cycle if at least one of the flags is set. The latter may be useful when the quality of signals used for calculating one of the parameters is poor. This may occur in systems where the membrane flow used for calculating membrane resistance is very small or otherwise noisy. In some embodiments, the process may even monitor only a single parameter, e.g. only a parameter indicative of the feed channel resistance, and base the termination decision on said single monitored parameter.

As will be apparent from the above description, embodiments of the adaptive chemical cleaning-in-place (CIP) process for membrane filtration systems described herein allow an improved control of the CIP process, in particular by reliably determining one or more of the following:
How long each chemical should be recirculated on the feed side of the membrane, to save on CIP downtime and energy consumption.
How many recirculation cycles should be used for optimum effect, to maximize CIP cleaning efficiency, as well as reduce downtime and membrane chemical exposure.
What is the economic efficiency of a given CIP recipe in a given application, to facilitate the selection of correct CIP chemicals and procedure for every system.

In summary, embodiments of the adaptive CIP functionality for membrane filtration systems optimizes the length of each CIP batch, by assuring only the minimum necessary length for every cleaning cycle and flushing cycle, as well as optimizes the number of CIP batches by making sure that the desired cleaning effect is achieved with a minimum number of CIP batches. This way, the algorithm makes the most of the chemicals available to it and optimizes the cleaning effect autonomously. On top of that, the adaptive CIP cleaning process may calculate the overall cost for a given CIP recipe, and as such can be used to benchmark chemicals and their combinations. By providing an insight into every individual cleaning stage, embodiments of the adaptive CIP process can determine which chemicals under-perform and suggest changing them to more efficient alternatives. This way, the user can decide which criteria are most important for them and select CIP recipes that are cheapest, simplest or shortest.

Embodiments of at least some steps of the method described herein may be computer-implemented. In particular, embodiments of at least some steps of the method may be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

### LIST OF REFERENCE NUMERALS

10 Membrane filter system
100 Membrane filter apparatus
110 Membrane filter module
111 Feed channel
112 Membrane
113 permeate channel
114 Total resistance
115 Feed channel resistance
116 Membrane resistance
120 Hydraulic system
121 Feed pump
122 Permeate valve
123 Feed valve
124 Feed conduit
125 Permeate conduit
126 Concentrate conduit
130 CIP system
131 CIP tank
132 Chemical cleaning agent supply pump
133 CIP supply conduit
134 CIP supply valve
135 CIP recirculation conduit
136 CIP recirculation valve
137 CIP permeate conduit
138 CIP permeate valve
140 Sensors
141 Feed flow sensor
142 Feed pressure sensor
143 Permeate flow sensor
144 Permeate pressure sensor
145 Concentrate pressure sensor
146 Conductivity sensor
147 Temperature sensor
148 pH sensor
200 Data processing system
501 CIP batch
S1, . . . , S19 Process steps

1. A cleaning-in-place method for cleaning a membrane filter module, the membrane filter module including a membrane having a feed side and a permeate side and being configured to filter a fluid passing through the membrane from the feed side to the permeate side, wherein the method comprises performing a sequence of process cycles, the sequence comprising at least one monitored process cycle, the monitored process cycle comprising the steps of:
providing a flow of a liquid through the membrane and/or across the feed side of the membrane;
monitoring at least one hydraulic parameter associated with the provided flow of the liquid; and
terminating the flow of the liquid, when the at least one monitored hydraulic parameter meets a predetermined cycle completion criterion.

2. A method according to claim 1, wherein the monitored process cycle is a cleaning-in-place cycle and the liquid is a cleaning liquid and comprises a chemical cleaning agent.

3. A method according to claim 2, wherein the cleaning-in-place cycle comprises providing a recirculation flow of the liquid across the feed side of the membrane and allowing a minor permeate flow, smaller than the recirculation flow, from the feed side of the membrane through the membrane.

4. A method according to claim 1, wherein the monitored process cycle is a flushing cycle and the liquid is a flushing liquid or a flushing liquid comprising feed or permeate water.

5. A method according to claim 4, wherein the flushing cycle comprises providing a flow of the flushing liquid or from the feed side of the membrane and across the feed side of the membrane.

6. A method according to claim 1, wherein the sequence of process cycles comprises one or more cleaning-in-place cycles and one or more flushing cycles.

7. A method according to claim 6, wherein performing each process cycle comprises:
providing a flow of a liquid through the membrane and/or across the feed side of the membrane;
monitoring at least one hydraulic parameter associated with the provided flow of the liquid; and
terminating the flow of the liquid, when the at least one monitored hydraulic parameter meets a predetermined cycle completion criterion.

8. A method according to claim 6, wherein performing at least one monitored process cycle of the plurality of process cycles comprises:
recording a current resulting value of the at least one monitored hydraulic parameter resulting from said monitored process cycle;
comparing the current resulting value of the at least one monitored hydraulic parameter with a previously recorded resulting value of the at least one monitored hydraulic parameter resulting from a previous process cycle of the plurality of process cycles, the previous process cycle preceding said monitored process cycle; and
terminating the sequence of process cycles when the current and previously recorded values of the monitored hydraulic parameter meet a predetermined process completion criterion.

9. A method according to claim 1, wherein the at least one hydraulic parameter is indicative of a membrane resistance against a flow through the membrane and/or indicative of a feed channel resistance of a feed channel directing a flow of the liquid across the feed side of the membrane.

10. A method according to claim 9, comprising determining the at least one hydraulic parameter indicative the membrane resistance from a measured liquid pressure on the feed side and the permeate side of the membrane and from a measured permeate flow through the membrane.

11. A method according to claim 9, comprising determining the at least one hydraulic parameter indicative of the feed channel resistance from a measured supply pressure into the feed channel, from a recirculation pressure out of the feed channel and from a recirculation flow out of the feed channel.

12. A method according to claim 1, wherein the cycle completion criterion is fulfilled when the at least one monitored hydraulic parameter reaches a stationary state following a period of increase or decrease of said at least one monitored hydraulic parameter.

13. A method according to claim 12, wherein the stationary state is a state during which a rate of change of the at least one monitored hydraulic parameter is below a predetermined threshold.

14. A method according to claim 12, wherein the at least one hydraulic parameter includes a first parameter indicative of a membrane resistance and a second parameter indicative of a feed channel resistance and wherein the cycle completion criterion is fulfilled when each of the first and second parameters reaches a stationary state.

15. A method according to claim 1, wherein the membrane filter is a nanofiltration or reverse osmosis filter.

16. A membrane filter system comprising at least one membrane and being configured to perform a cleaning-in-place process as defined in claim 1.

17. A computer-implemented process of controlling a cleaning-in-place process for cleaning a membrane filter module, the membrane filter module including a membrane having a feed side and a permeate side and being configured to filter a fluid passing through the membrane from the feed side to the permeate side; wherein the cleaning-in place process comprises at sequence of process cycles, wherein the method comprises controlling at least one monitored process cycle of the sequence of process cycle, wherein controlling to the monitored process cycle comprises:
controlling the membrane filter system to provide a flow of a liquid through the membrane and/or across the feed side of the membrane;
monitoring at least one hydraulic parameter associated with the provided flow of the liquid; and
controlling the membrane filter system to terminate the flow of the liquid, when the at least one monitored hydraulic parameter meets a predetermined cycle completion criterion.

18. A computer program comprising computer program code configured, when executed by a data processing system, to cause the data processing system to perform the steps of the method according to claim 17.

19. A data processing system configured to perform the steps of the method according to claim 17.
